(19) United States
(12) Patent Application Publication
(10) Pub. No.: US 2006/0252909 A1
(43) Pub. Date: Nov. 9, 2006

(54) Direct synthesis method for the production of etherified melamine resin condensates, melemine resin condensates, and use thereof

(76) Inventors: Steffen Pfeiffer, Linz (AT); Manfred Ratzsch, Wilhering (AT); Hartmut Bucka, Eggendorf (AT); Günter Tappeiner, Lenano (IT)

Correspondence Address: THE WEBB LAW FIRM, P.C., 700 KOPPERS BUILDING, 436 SEVENTH AVENUE, PITTSBURGH, PA, 15219, US

(21) Appl. No.: 10/539,789

(22) PCT Filed: Dec. 18, 2003
(86) PCT No.: PCT/EP03/14454

§ 371 Date: Apr. 3, 2006

(30) Foreign Application Priority Data
Dec. 19, 2002 (DE) 10261804.6

(51) Int. Cl. C08G 69/10

(52) U.S. Cl. 528/328

(57) ABSTRACT

The invention relates to a direct synthesis method for producing etherified melamine resin condensates having average molar masses of 500 to 50,000. The method is characterized by the fact that a) an etherified melamine resin precondensate is produced in an alcoholic solution in a first reaction step; b) the etherified melamine resin precondensate is concentrated in an alcoholic solution in at least one condensation step, C₄ to C₁₈ alcohols, diols of type HO—R—OH, and/or tetravalent alcohols that are based on erythritol being added to the melamine resin precondensate during and/or following the concentration process; c) the concentrated melamine resin precondensate is reacted by means of a mixer, especially a kneader, in a second reaction step.

The invention relates to a direct synthesis process for etherified melamine resin condensates according to the precharacterizing clause of claim 1, to a use of the melamine resin condensates according to claim 23 and to melamine resin condensates according to claim 24.

Direct synthesis processes for preparing etherified melamine resin condensates are known.

According to DE-A 25 16 349 and U.S. Pat. No. 4,425,466, etherified methylolaminotriazines can be prepared by reacting aminotriazines with formaldehyde and alcohols in the presence of strong organic acids at from 80 to 130° C. BE-A 623 888 describes the use of ion exchangers in the direct preparation of etherified formaldehyde resins. The disadvantage with these known processes is that they cannot prepare relatively highly condensed melamine resin ethers, and that the melamine resin ethers formed still contain hydroxymethyleneamino groups bonded to the triazine rings of the melamine resin condensates and still retain —NH—CH₂—O—CH₂—NH— groups linking the triazine rings, the result of this being that, during curing, formaldehyde is eliminated and microcracks form in the cured resins and coatings.

It is an object of the invention to provide a direct synthesis process for preparing etherified melamine resin condensates which have average molecular weights of from 500 to 50 000 and which are free from hydroxy-methyleneamino groups bonded to the triazine rings and from —NH—CH₂—O—CH₂—NH— groups linking the triazine rings.

This object is achieved by way of a direct synthesis process in which

a) in a first step of the reaction, an etherified melamine resin precondensate is prepared in alcoholic solution,

b) in at least one vaporization step, the concentration of the etherified melamine resin precondensate in alcoholic solution is increased, C₄-C₁₈ alcohols, diols of the type represented by HO—R—OH and/or tetrahydric alcohols based on erythritol being added to the melamine resin precondensate prior to, during and/or after the concentration-increase process,

c) in a second step of the reaction, the increased-concentration melamine resin precondensate is reacted, using a mixer, in particular a kneader.

In one advantageous embodiment of the inventive process, after the second step of the reaction the etherified melamine resin condensate is discharged and pelletized.

Methanol is advantageously used as alcohol in the first step of the reaction. There are two advantageous methods for carrying out the methylolation and the etherification.

On the one hand, the methylolation and the etherification are executed in succession, and on the other hand the methylolation and the etherification are executed simultaneously.

In the first method, by way of example, the melamine is first methylolated at a preferred pH of from about 7 to 9 by adding a formaldehyde component, such as formaldehyde or a mixture of formaldehyde and methanol, and the resultant methylolmelamine is then etherified under acidic conditions, using an alcohol, preferably methanol. This etherification preferably takes place at temperatures of from 70 to 160° C., at pressures from 1.3 to 20 bar and at a preferred pH of from 5.5 to 6.5. The reaction time may be varied from a few seconds to 1 hour and is typically from 5 to 40 minutes. Continuous and/or batchwise operation is possible here.

The second method consists in simultaneous methylolation and etherification in the first step of the reaction. By way of example, methanol is the alcohol used for the etherification. By way of example, the dispersion comprising from 10 to 60% by weight of melamine is prepared by introducing melamine into methanol or a mixture of from 5 to 95% by weight of methanol and from 95 to 5% by weight of C₄-C₈ hydrocarbons at a temperature of from 30 to 95° C. Once a pH of from 5.5 to 6.5 has been established, an aqueous formaldehyde solution with a formaldehyde concentration of from 35 to 55% by weight and/or p-formaldehyde is metered in as formaldehyde component. The formaldehyde solution may comprise up to 15% by weight of methanol. The reaction mixture is reacted at a reaction temperature of from 70 to 110° C., at a pressure of from 1.3 to 5 bar and for a reaction time of from 5 to 40 minutes to give etherified melamine precondensates. The resultant alcoholic solution of the etherified melamine resin precondensate is cooled to 40-60° C.

The molar melamine/formaldehyde ratio is advantageously from 1:2 to 1:4. The molar melamine/methanol ratio is advantageously from 1:10 to 1:20. These molar ratios apply to both methods for carrying out the first step of the reaction.

Particularly suitable C₄-C₈ hydrocarbons for dispersing melamine in mixtures of from 5 to 95% by weight of methanol and from 95 to 5% by weight of C₄-C₈ hydrocarbons in the first step of the reaction are: isobutane, pentane, heptane and/or isooctane.

In the first step of the reaction in one embodiment of the inventive process, the formaldehyde component used comprises a mixture of 35% by weight of formaldehyde, 15% by weight of methanol and 50% by weight of water. Alternatively, a mixture of 50% by weight of formaldehyde and 50% by weight of water may be used in the first step of the reaction.

Paraformaldehyde may also be used as formaldehyde component in the first step of the reaction.

The preferred reaction temperature in the first step of the reaction is in the range from 70 to 160° C., particularly preferably from 95 to 100° C.

In one preferred embodiment of the first step of the reaction, the reaction takes place in the presence of acidic, or of a mixture of acidic and basic, ion exchangers. By way of example, suitable ion exchangers are ion exchangers based on chloromethylated and trimethylolamine-aminated styrene-divinylbenzene copolymers or based on sulphonated styrene-divinylbenzene copolymers.

The concentration of the alcoholic, preferably methanolic, melamine resin precondensate solution obtained in the first step of the reaction is then increased through at least one vaporization step.

It is preferable to carry out two vaporization steps. By way of example, once a pH of less than 10 has been established, the concentration of the etherified melamine resin precondensate is increased in a first evaporator stage for removal of the water/methanol mixture at temperatures of from 60 to 100° C. and at a pressure of from 0.2 to 1 bar, until the solids content of etherified melamine resin precondensate is from 65 to 85% by weight, and is increased in a second evaporator stage intended to achieve a solids content of etherified melamine resin precondensate of from 95 to 99% by weight at from 60 to 120° C. and from 0.1 to 1 bar.

Prior to and/or during the concentration increase process, i.e. prior to the first and/or prior to the second evaporator stage and/or after the concentration-increase process, i.e. prior to the second step of the reaction, C₄-C₁₈ alcohols, diols of the type represented by HO—R—OH and/or tetrahydric alcohols based on erythritol may be added to the melamine resin precondensate. The molecular weights of these diols are preferably from 62 to 20 000.

Prior to and/or during the concentration increase-process, i.e. prior to the first and/or prior to the second vaporization stage and/or after the concentration-increase process, i.e. prior to the second step of the reaction, anhydrides and/or acids dissolved in alcohols or in water may be added to the melamine resin precondensate.

The ratio of the ether groups of the melamine precondensate to the hydroxy groups of the added C₄-C₁₈ alcohols and/or diols may be from 1:0.5 to 1:0.1, for example. Examples of suitable C₄-C₁₈ alcohols are butanol, ethylhexyl alcohol, dodecyl alcohol and stearyl alcohol.

The added diols are preferably diols where the substituent R has one of the following structures:
C₂-C₁₈-alkylene,
—CH (CH₃)—CH₂—O—(C₂-C₁₂)-alkylene-O—CH₂—CH (CH₃)—,
—CH (CH₃)—CH₂—O—(C₂-C₁₂)-arylene-O—CH₂—CH (CH₃)—,
—(CH₂—CH₂—CH₂—CH₂—CH₂—CO—)ₓ—(CH₂—CHR)_{y}—
—[CH₂—CH₂—O—CH₂—CH₂]ₙ—,
—[CH₂—CH (CH₃)—O—CH₂—CH (CH₃)]ₙ—,
—[—O—CH₂—CH₂—CH₂—CH₂—]ₙ—,
—[(CH₂)₂₋₈—O—CO—(C₆-C₁₄)-arylene-CO—O—(CH₂)₂₋₈—]ₙ—,
—[(CH₂)₂₋₈—O—CO—(C₂-C₁₂)-alkylene-CO—O—(CH₂)₂₋₈—]ₙ—,
where n=1-200;
sequences which contain siloxane groups and are represented by the type 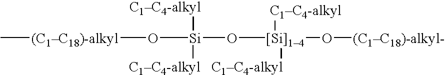
polyester sequences which contain siloxane groups and are represented by the type —[(X)ᵣ—O—CO—(Y)ₛ—CO—O—(X)ᵣ]—, where 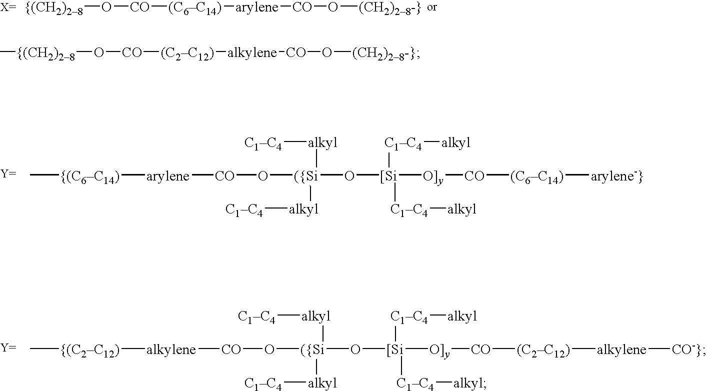
   where r=1-70; s=1-70 and y=3-50;
polyether sequences which contain siloxane groups and are represented by the type 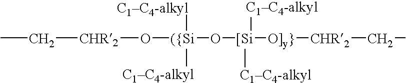
where R′₂=H; C₁-C₄-alkyl and y=3-50;

sequences based on alkylene oxide adducts of melamine and represented by the type of
2-amino-4,6-di-(C₂-C₄)alkyleneamino-1,3,5-triazine sequences

phenol ether sequences based on dihydric phenols and on C₂-C₈ diols and represented by the type of
—(C₂-C₈)alkylene-O—(C₆-C₁₈)-arylene-O—(C₂-C₈)-alkylene sequences.

Examples of diols of the type represented by HO—R₁—OH, where R₁=C₂-C₁₈-alkyl, are ethylene glycol, butanediol, octanediol, dodecanediol and octadecanediol.

Examples of diols of the type represented by HO—R₂—OH, where

R₂=—[CH₂—CH₂—O—CH₂—CH₂]ₙ— and n=1-200, are polyethylene glycols with molecular weights of from 500 to 5 000.

Examples of diols represented by the type HO—R₃—OH, where

R₃=—[CH₂—CH(CH₃)—O—CH₂—CH(CH₃)]ₙ— and n=1-200, are polypropylene glycols with molecular weights of from 500 to 5 000.

Examples of diols of the type represented by HO—R₄—OH, where R₄=—[—O—CH₂—CH₂—CH₂—CH₂—]ₙ— and n=1-200, are polytetrahydrofurans with molecular weights of from 500 to 5 000.

Examples of diols of the type represented by HO—R₅—OH, where

R₅=—[(CH₂)₂₋₈—O—CO—(C₆-C₁₄)-arylene-CO—O—(CH₂)₂₋₈]ₙ— and n=1-200, are esters and polyesters based on saturated dicarboxylic acids, such as terephthalic acid, isophthalic acid or naphthalenedicarboxylic acid and on diols, such as ethylene glycol, butanediol, neopentyl glycol and/or hexanediol. Preference is given to bis(hydroxyethyl) terephthalate as ester.

Examples of diols of the type represented by HO—R₆—OH, where

R₆=—[(CH₂)₂₋₈—O—CO—(C₂-C₁₂)-alkylene-CO—O—(CH₂)₂₋₈—]ₙ and n=1-200, are polyesters based on saturated dicarboxylic acids, such as adipic acid and/or succinic acid, on unsaturated dicarboxylic acids, such as maleic acid, fumaric acid and/or itaconic acid, and on diols, such as ethylene glycol, butanediol, neopentyl glycol and/or hexanediol.

Examples of diols of the type represented by HO—R₇—OH, where

R₇=sequences containing siloxane groups and represented by the type

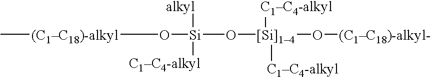

are 1,3-bis(hydroxybutyl)tetramethyldisiloxane and 1,3-bis(hydroxyoctyl)tetraethyldisiloxane.

Examples of polyester sequences having diols containing siloxane groups and represented by the type HO—R₈—OH, where
R₈=—[(X)ᵣ—O—CO—(Y)ₛ—CO—O—(X)ᵣ]—,
where

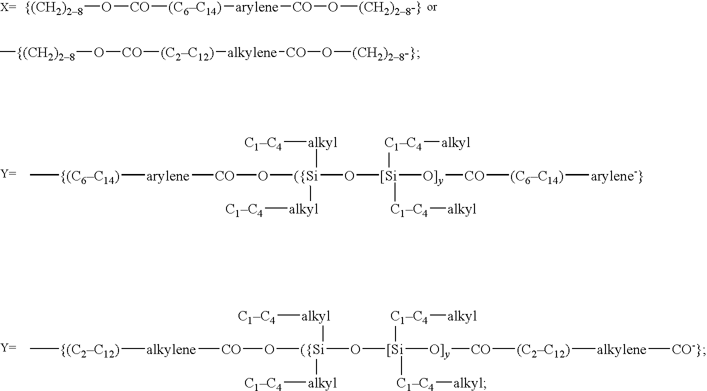

where r=1-70; s=1-70 and y=3-50, are polyesters containing hydroxy end groups and based on aromatic C₆-C₁₄-arylenedicarboxylic acids, such as terephthalic acid or naphthalenedicarboxylic acid, or on aliphatic C₂-C₁₂-alkylenedicarboxylic acids, such as adipic acid, maleic acid or pimelic acid. Diols, such as ethylene glycol, butanediol, neopentyl glycol or hexanediol, and on siloxanes, such as hexamethyl-disiloxane or α,ω-dihydroxypolydimethylsiloxane.

Examples of polyetherdiols HO—R₉—OH containing siloxane groups, where R₉ is polyether sequences represented by the type

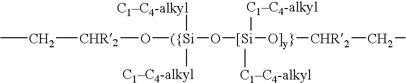

where R′₂=H; C₁-C₄-alkyl and y=from 3 to 50 are polyetherdiols based on siloxanes, such as hexamethyl-disiloxane or α,ω-dihydroxypolydimethylsiloxane, and on alkylene oxides, such as ethylene oxide or propylene oxide.

Examples of diols based on alkylene oxide adducts of the melamine represented by the type

2-amino-4,6-bis(hydroxy-(C₂-C₄)-alkyleneamino)-1,3,5-triazine are diols based on melamine and ethylene oxide or propylene oxide.

Examples of phenol ether diols based on dihydric phenols and C₂-C₈ diols represented by the type

bis (hydroxy-(C₂-C₈)-alkylene-O—) (C₆-C₁₈)-arylene are ethylene oxide adducts or propylene oxide adducts onto diphenylolpropane.

Besides diols as polyhydric alcohols, trihydric alcohols, such as glycerol, or tetrahydric alcohols based on erythritol, or mixtures of these with dihydric alcohols, may also be used in the direct synthesis process.

If C₄-C₁₈ alcohols and/or diols of the type represented by HO—R—OH are added prior to the first evaporator stage and/or prior to the second evaporator stage, mixing sections are installed to homogenize the components prior to the evaporator stages.

In a second step of the reaction, the melamine resin precondensate treated with alcohols and/or with diols is reacted in a kneader. This is preferably a continuous kneader. The reaction time in the kneader is from about 2 to 12 min, and the reaction temperature is from about 180 to 250° C. Unreacted reactants are removed during venting in the kneader, and the etherified melamine resin condensate is then preferably discharged and granulated.

Up to 75% by weight of fillers and/or reinforcing fibres, other reactive polymers of the type represented by ethylene copolymers, maleic anhydride copolymers, modified maleic anhydride copolymers, poly(meth)acrylates, polyamides, polyesters and/or polyurethanes may also be added to the kneader, as well as up to 2% by weight of stabilizers, UV absorbers and/or auxiliaries, each weight being based on the etherified melamine resin condensates.

The continuous kneaders in the second step of the reaction may comprise twin-screw extruders which have vent zones after the feed zone and also after the reaction zone. These twin-screw extruders may have an L/D ratio of from 32 to 48 with a corotating arrangement of screws.

In principle, the kneaders used may also comprise other, at least to some extent self-cleaning, continuously operating machines suitable for the processing of highly viscous substances and having vacuum venting (e.g. Buss Co-Kneader, single-screw extruders, extruders in a cascade arrangement, single- or twin-screw kneaders of the type represented by LIST ORP; CRP, Discotherm, etc.).

To remove any inhomogeneity, the melt may be conveyed into a melt filter, using a gear pump. The melt may be converted into pellets in pelletizers or in pastille-production systems by metering the melt through a feed device onto a continuous steel belt and cooling and solidifying the pastilles deposited.

Examples of suitable fillers which may be metered into the continuous kneader during the direct synthesis process are: Al₂O₃, Al(OH)₃, barium sulphate, calcium carbonate, glass beads, siliceous earth, mica, powdered quartz, powdered slate, hollow microbeads, carbon black, talc, powdered stone, wood flour, cellulose powder and/or ground shells or ground kernels, e.g. ground peanut shells or ground olive kernels. Preferred fillers are phyllosilicates of the type represented by montmorillonite, bentonite, kaolinite, muscovite, hectorite, fluorohectorite, kanemite, revdite, grumantite, ilerite, saponite, beidelite, nontronite, stevensite, laponite, taneolite, vermiculite, halloysite, volkonskoite, magadite, rectorite, kenyaite, sauconite, borofluorophlogopites and/or synthetic smectites.

Examples of suitable reinforcing fibres which may be metered into the continuous kneader during the direct synthesis process are inorganic fibres, in particular glass fibres and/or carbon fibres, natural fibres, in particular cellulose fibres, such as flax, jute, kenaf, and wood fibres, and/or synthetic fibres, in particular fibres of polyacrylonitrile, of polyvinyl alcohol, of polyvinyl acetate, of polypropylene, of polyesters and/or of polyamides.

Examples of reactive polymers of the type represented by ethylene copolymers, which can be metered into the continuous kneader during the direct synthesis process are partially hydrolyzed ethylene-vinyl acetate copolymers, ethylene-butyl acryl-acrylic acid copolymers, ethylene-hydroxyethyl acrylate copolymers and ethylene-butyl acrylate-glycidyl methacrylate copolymers.

Examples of reactive polymers of the type represented by maleic anhydride copolymers which may be metered into the continuous kneader during the direct synthesis process are C₂-C₂₀ olefin-maleic anhydride copolymers and copolymers of maleic anhydride and C₈-C₂₀ vinylaromatics.

Examples of the C₂-C₂₀ olefin components which may be present in the maleic anhydride copolymers are ethylene, propylene, 1-butene, isobutene, diisobutene, 1-hexene, 1-octene, 1-heptene, 1-pentene, 3-methyl-1-butene, 4-methyl-1-pentene, methylethyl-1-pentene, ethyl-1-pentene, ethyl-1-hexene, 1-octadecene and 5,6-dimethylnorbornene.

Examples of the C₈-C₂₀ vinylaromatic components which may be present in the maleic anhydride copolymers are styrene, α-methylstyrene, dimethylstyrene, isopropenyl styrene, p-methylstyrene and vinylbiphenyl.

Examples of modified maleic anhydride copolymers which may be metered into the continuous kneader during the direct synthesis process are partially or completely esterified, amidated or, respectively, imidated maleic anhydride copolymers.

Particularly suitable substances are modified copolymers of maleic anhydride with C₂-C₂₀ olefins or with C₈-C₂₀ vinylaromatics with a molar ratio of from 1:1 to 1:9 and weight-average molecular weights of from 5 000 to 500 000, which have been reacted with ammonia, with C₁-C₁₈ monoalkylamines, with C₆-C₁₈ aromatic monoamines, with C₂-C₁₈ monoaminoalcohols, with monoaminated poly(C₂-C₄-alkylene) oxides of molecular weight from 400 to 3 000, and/or with monoetherified poly(C₂-C₄-alkylene) oxides of molecular weight from 100 to 10 000, the molar ratio of anhydride groups in the copolymer to ammonia, amino groups of the C₁-C₁₈ monoalkylamines, of the C₆-C₁₈ aromatic monoamines or the C₂-C₁₈ monoaminoalcohols or monoaminated poly(C₂-C₄-alkylene) oxide and/or hydroxyl groups poly(C₂-C₄-alkylene) oxide being from 1:1 to 20:1.

Examples of reactive polymers of the type represented by poly(meth)acrylates which can be metered into the continuous kneader during the direct synthesis process are copolymers based on functional unsaturated (meth)acrylate monomers, such as acrylic acid, hydroxyethyl acrylate, glycidyl acrylate, methacrylic acid, hydroxybutyl methacrylate or glycidyl methacrylate, and on non-functional unsaturated (meth)acrylate monomers, such as ethyl acrylate, butyl acrylate, ethylhexyl acrylate, methyl methacrylate ethyl acrylate and/or butyl methacrylate, and/or on C₈-C₂₀-vinylaromatics. Preference is given to copolymers based on methacrylic acid, hydroxyethyl acrylate, methyl methacrylate and styrene.

Examples of reactive polymers of the type represented by polyamides which may be metered into the continuous kneader during the direct synthesis process are nylon-6, nylon-6,6, nylon-11, nylon-12, polyaminoamides composed of polycarboxylic acids and of polyalkyleneamines, and also the corresponding methoxylated polyamides.

Examples of reactive polymers of the type represented by polyesters which may be metered into the continuous kneader during the direct synthesis process are polyesters with molecular weights of from 2 000 to 15 000 composed of saturated dicarboxylic acids, such as phthalic acid, isophthalic acid, adipic acid and/or succinic acid, of unsaturated dicarboxylic acids, such as maleic acid, fumaric acid and/or itaconic acid, and of diols, such as ethylene glycol, butanediol, neopentyl glycol and/or hexanediol. Preference is given to branched polyesters based on neopentyl glycol, trimethylolpropane, isophthalic acid and azelaic acid.

Examples of reactive polymers of the type represented by polyurethanes which may be metered into the continuous kneader during the direct synthesis process are non-crosslinked polyurethanes based on tolylene diisocyanate, diphenylmethane diisocyanate, butane diisocyanate and/or hexane diisocyanate as diisocyanate components and butanediol, hexanediol and/or polyalkylene glycols as diol components with molecular weights of from 200 to 30 000.

Examples of suitable stabilizers and UV absorbers which may be metered into the continuous kneader during the direct synthesis process are piperidine derivatives, benzophenone derivatives, benzotriazole derivatives, triazine derivatives and/or benzofuranone derivatives.

Examples of suitable auxiliaries which may be metered into the continuous kneader during the direct synthesis process are latent hardeners, such as ammonium sulphate and/or ammonium chloride, and/or processing aids such as calcium stearate, magnesium stearate and/or waxes.

The particular advantage of the direct synthesis process of the invention is that the molecular weight of the etherified melamine resin condensates can be controlled with precision via the addition of C₄-C₁₈ alcohols and/or diols represented by the type HO—R—OH. Without addition of C₄-C₁₈ alcohols and/or diols represented by the type HO—R—OH, the increase in molecular weight in the etherified melamine resin condensates takes place in an uncontrolled manner by way of the azomethine groups present therein. The regulator function of the added C₄-C₁₈ alcohols and/or diols represented by the type HO—R—OH consists in the deactivation, by their hydroxy groups, of the azomethine groups present in the etherified melamine resin condensates. When diols are added, the deactivation takes place with simultaneous linking of two melamine resin clusters.

The inventively prepared etherified melamine resin condensates have average molecular weights of from 500 to 50 000.

The inventively prepared etherified melamine resin condensates are preferably mixtures with average molecular weights of from 500 to 2 500, particularly preferably from 800 to 1 500, composed of tris(methoxy-methylamino)triazine and its higher-molecular-weight oligomers.

The etherified melamine resin condensates prepared by the process of the invention are preferably suitable for processing in the melt, in particular as hot-melt adhesives and for producing sheets, pipes, profiles, injection mouldings, fibres, coatings and foams, or for processing from solution or dispersion in the form of an adhesive, impregnating resin, surface-coating resin or laminating resin or for producing foams, microcapsules or fibres.

The particular advantage of the etherified melamine resin condensates prepared by the direct synthesis process with average molecular weights of from 500 to 50 000 is that, due to higher melt viscosity when compared with conventional triazine derivative precondensates, such as melamine-formaldehyde precondensates, they can be processed like thermoplastics by processes operating in the melt, and that the hardness and flexibility of the resultant products are adjustable over a wide range of properties.

When comparison is made with moulding compositions based on low-molecular-weight amino plastic precondensates, there is a dramatic reduction in the proportion of volatile cleavage products present during the curing of the etherified melamine resin condensates prepared by the direct synthesis process, during the shaping of the melt to give the product. For this reason, crack-free products can be produced from the etherified melamine resin condensates with short cycle times.

Preferred application sectors for the etherified melamine resin condensates prepared by the direct synthesis process are hot-melt adhesives, and also the production of sheets, pipes, profiles, injection mouldings, fibres and foams.

As long as they do not comprise any fillers or any other reactive polymers, the etherified melamine resin condensates prepared by the direct synthesis process are soluble in polar solvents of the type represented by C₁-C₁₀ alcohols, dimethylformamide or dimethyl sulphoxide in concentrations of up to 60% by weight. The solutions or dispersions are suitable as an adhesive, impregnating agent, surface-coating resin formulation or laminating resin formulation, or for producing foams, microcapsules or fibres. The advantages of the solutions or dispersions of the etherified melamine resin condensates prepared by the direct synthesis process, when compared with conventional triazine resin precondensates are higher viscosity and the resultant better flow properties or higher strengths of uncured intermediate products during the production of fibres or of foam.

The melamine resin condensates are advantageously free from hydroxymethyleneamino groups bonded to the triazine rings of the melamine resin condensate and from —NH—CH₂—O—CH₂—NH— groups linking triazine rings.

The object is also achieved by way of melamine resin products which can be produced using the etherified melamine resin condensates prepared by the direct synthesis process.

The invention is illustrated by the following examples.

### INVENTIVE EXAMPLE 1

A melamine dispersion is prepared by introducing 12.0 kg of melamine into 42.6 kg of methanol at 95° C. in a stirred autoclave, and once a pH of 6 has been established in the stirred autoclave a mixture, temperature-controlled in advance to 90° C., of 10 kg of formaldehyde, 2.7 kg of methanol and 16.6 kg of water is metered in under pressure as formaldehyde component, and the reaction mixture is reacted at a reaction temperature of 95° C. for a reaction time of 5 min.

After cooling to 65° C., a pH of 9 is established by adding N/10 sodium hydroxide solution, and the etherified melamine resin precondensate dissolved in the water/methanol mixture is transferred, after addition of 21.0 kg of butanol, into a first vacuum evaporator, in which the solution of the etherified melamine resin precondensate is concentrated at 80° C. to give a highly concentrated melamine resin solution whose solids content is 75% by weight and whose butanol content is 10% by weight.

The highly concentrated solution of the etherified melamine resin is subsequently transferred into a second vacuum evaporator and concentrated at 90° C. to give a syrupy melt whose solids content is 95% by weight and whose butanol content is 5% by weight.

The syrupy melt is metered into the feed hopper of a GL 27 D44 (Leistritz) laboratory extruder with vacuum venting downstream of the reaction zone prior to product discharge, temperature profile 220° C./220° C./220° C./240° C./240° C./240° C./240° C./240° C./240° C./190° C./150° C., extruder rotation rate 150 rpm, and, after a residence time of 3.2 min in the reaction zone, volatile content is removed at 100 mbar, and the discharged extrudate is chopped in a pelletizer.

The etherified melamine resin condensate has a weight-average molecular weight (GPC) of 800 and a butoxy group content of 4.1% by weight. Neither hydroxymethyleneamino groups bonded to the triazine rings of the melamine resin condensate nor —NH—CH₂—O—CH₂—NH— groups linking triazine rings are discernible in the IR spectrum.

### INVENTIVE EXAMPLE 2

A melamine dispersion is prepared by introducing 12.0 kg of melamine into 42.6 kg of methanol at 95° C. in a stirred autoclave, and once a pH of 6.1 has been established in the stirred autoclave a mixture, temperature-controlled in advance to 92° C., of 8.6 kg of formaldehyde and 8.6 kg of water is metered in under pressure as formaldehyde component, and the reaction mixture is reacted at a reaction temperature of 95° C. for a reaction time of 6 min. After cooling to 65° C., a pH of 9.2 is established by adding N/10 sodium hydroxide solution, and the etherified melamine resin precondensate dissolved in the water/methanol mixture is transferred into a first vacuum evaporator, in which the solution of the etherified melamine resin precondensate is concentrated at 80° C. to give a highly concentrated melamine resin solution whose solids content is 78% by weight.

The highly concentrated solution of the etherified melamine resin is subsequently mixed, in a mixing section, with 0.8 kg of Simulsol BPLE (oligoethylene glycol ether of bisphenol A), transferred into a second vacuum evaporator and concentrated at 90° C. to give a syrupy melt whose solids content is 98% by weight and whose butanol content is 2% by weight.

The syrupy melt is metered into the feed hopper of a GL 27 D44 (Leistritz) laboratory extruder with vacuum venting zones downstream of the feed zone and also downstream of the reaction zone prior to product discharge, temperature profile 220° C./220° C./220° C./240° C./240° C./240° C./240° C./240° C./240° C./190° C./150° C., extruder rotation rate 150 rpm, and the reaction mixture is devolatilized at 150 mbar, and, after a residence time of 3.2 min in the reaction zone, volatile content is removed at 100 mbar, and the discharged extrudate is chopped in a pelletizer.

The etherified melamine resin condensate has a weight-average molecular weight (GPC) of 10 000. Neither hydroxymethyleneamino groups bonded to the triazine rings of the melamine resin condensate nor —NH—CH₂—O—CH₂—NH— groups linking triazine rings are discernible in the IR spectrum.

### INVENTIVE EXAMPLE 3

A melamine dispersion is prepared by introducing 12.0 kg of melamine into 42.6 kg of methanol at 95° C. in a stirred autoclave, and once a pH of 5.9 has been established in the stirred autoclave a mixture, temperature-controlled in advance to 90° C., of 8.6 kg of formaldehyde, 3.5,kg of methanol and 9.9 kg of water is metered in under pressure as formaldehyde component, and the reaction mixture is reacted at a reaction temperature of 95° C. for a reaction time of 10 min.

After cooling to 65° C., a pH of 9 is established by adding N/10 sodium hydroxide solution, and the etherified melamine resin precondensate dissolved in the water/methanol mixture is transferred, after addition of 21.0 kg of butanol, into a first vacuum evaporator, in which the solution of the etherified melamine resin precondensate is concentrated at 82° C. to give a highly concentrated melamine resin solution whose solids content is 76% by weight and whose butanol content is 8% by weight.

The highly concentrated solution of the etherified melamine resin is subsequently transferred into a second vacuum evaporator and concentrated at 90° C. to give a syrupy melt whose solids content is 96% by weight and whose butanol content is 4.5% by weight.

The syrupy melt, mixed in a mixing section with 5.0 kg of polyethylene glycol (molecular weight 800), is metered into the feed hopper of a GL 27 D44 laboratory extruder with vacuum venting zones downstream of the feed zone and downstream of the reaction zone prior to product discharge, temperature profile 220° C./220° C./220° C./240° C./240° C./240° C./240° C./240° C./240° C./190° C./150° C., extruder rotation rate 150 rpm, and the reaction mixture is devolatilized at 150 mbar, and, after a residence time of 3.1 min in the reaction zone, volatile content is removed at 100 mbar, and the discharged extrudate is chopped in a pelletizer.

The etherified melamine resin condensate has a weight-average molecular weight (GPC) of 20 000 and a butoxy group content below 0.5% by weight. Neither hydroxymethyleneamino groups bonded to the triazine rings of the melamine resin condensate nor —NH—CH₂—O—CH₂—NH— groups linking triazine rings are discernible in the IR spectrum.

### INVENTIVE EXAMPLE 4

A melamine dispersion is prepared by introducing 1.0 kg of melamine into 3.6 kg of methanol at 98° C. in a 10 1 stirred autoclave, and once a pH of 6 has been established in the stirred autoclave 0.84 kg of p-formaldehyde is metered in as formaldehyde component, and stirring of the reaction mixture is continued at a reaction temperature of 95° C. until a clear solution has been obtained at that temperature.

After cooling to 65° C., a pH of 9 is established by adding N/10 sodium hydroxide solution, and the dissolved etherified melamine resin precondensate is transferred, after addition of 2.0 kg of butanol, into a first vacuum evaporator, in which the solution of the etherified melamine resin precondensate is concentrated at 80° C. to give a highly concentrated melamine resin solution whose solids content is 79% by weight and whose butanol content is 7% by weight.

The highly concentrated solution of the etherified melamine resin is subsequently transferred into a second vacuum evaporator and concentrated at 90° C. to give a syrupy melt whose solids content is 96% by weight and whose butanol content is 3.4% by weight.

The syrupy melt is metered into the feed hopper of a GL 27 D44 (Leistritz) laboratory extruder with vacuum venting downstream of the reaction zone prior to product discharge, temperature profile 220° C./220° C./220° C./240° C./240° C./240° C./240° C./240° C./240° C./190° C./150° C., extruder rotation rate 150 rpm, and, after a residence time of 3.2 min in the reaction zone, volatile content is removed at 100 mbar, and the discharged extrudate is chopped in a pelletizer.

The etherified melamine resin condensate has a weight-average molecular weight (GPC) of 4 200 and a butoxy group content of 3.8% by weight. Neither hydroxymethyleneamino groups bonded to the triazine rings of the melamine resin condensate nor —NH—CH₂—O—CH₂—NH— groups linking triazine rings are discernible in the IR spectrum.

### INVENTIVE EXAMPLE 5

A melamine dispersion is prepared by introducing 12.0 kg of melamine into 42.6 kg of methanol at 99° C. in a 100 1 stirred autoclave, and once a pH of 6.1 has been established in the stirred autoclave a mixture, temperature-controlled in advance to 92° C., of 8.6 kg of formaldehyde and 8.6 kg of water is metered in under pressure as formaldehyde component, and the reaction mixture is reacted at a reaction temperature of 90° C. for a reaction time of 15 min.

After cooling to 65° C., a pH of 9.0 is established by adding N/10 sodium hydroxide solution, and the etherified melamine resin precondensate dissolved in the water/methanol mixture is transferred, after addition of 10 kg of butanol, into a first vacuum evaporator, in which the solution of the etherified melamine resin precondensate is concentrated at 80° C. to give a highly concentrated melamine resin solution whose solids content is 80% by weight and whose butanol content is 3.4% by weight.

The highly concentrated solution of the etherified melamine resin is subsequently mixed in a mixing section with 2.0 kg of bis(hydroxyethyl)terephthalate and transferred into a second vacuum evaporator and concentrated at 90° C. to give a syrupy melt whose solids content is 98.5% by weight and whose butanol content is 1.5% by weight.

The syrupy melt is metered into the feed hopper of a GL 27 D44 (Leistritz) laboratory extruder with vacuum venting zones downstream of the feed zone and downstream of the reaction zone upstream of the ancillary-stream metering equipment, temperature profile 220° C./220° C./220° C./240° C./240° C./240° C./240° C./240° C./240° C./190° C./150° C., extruder rotation rate 150 rpm, and the reaction mixture is devolatilized at 150 mbar, and, after a residence time of 3.2 min in the reaction zone, volatile content is removed at 100 mbar, 4% by weight of Na montmorillonite (Südchemie AG) and 6% by weight of polyamide D1466 (Ems-Chemie), in each case based on the melamine used, being metered into the melt by way of the ancillary-flow metering equipment and homogenized and the discharged extrudate is chopped in a pelletizer.

### INVENTIVE EXAMPLE 6

The modified filled melamine resin ether of inventive Example 5 is finely ground to an average particle diameter of 0.07 mm, and used to produce prepregs via powdered application to cellulose nonwovens (120 g/m² Lenzing AG, Austria) followed by melting of the powder at about 160° C. in a field of infrared radiation. The amount of resin applied to the cellulose nonwoven prepregs produced is about 45% by weight.

The prepregs are cut to a size of 30×20 cm. To produce a moulding with curved edges similar to a U profile, three prepregs and an untreated cellulose nonwoven forming an upper side are mutually superposed in a compression mould (30×20 cm) preheated to 160° C., and the press is slowly closed, the prepregs being capable of slight deformation during this process since the resin has not yet cured. The temperature is raised to 185° C. under a pressure of 150 bar and the material is compression moulded for 12 min. The finished workpiece is removed and slowly cooled, and the flash produced by resin discharged at the vertical flash face of the compression mould is removed by grinding.

In the flexural test, specimens cut by a rotary cutter from the workpiece have a modulus of elasticity of 5.8 GPa, an elongation at maximum force of 3.1% and an impact strength of 11.8 kJ/m².

Even though the first stage of the process in the examples took place batchwise, the process of the invention may also be operated in a continuous system, using a reactor whose operation is correspondingly continuous.

The evaporators used may comprise falling-film evaporators, rotary evaporators, or else other types of evaporator.

The working of the invention is not restricted to the preferred examples given above. Rather, it is possible to conceive a number of variants which utilize fundamentally different embodiments of the inventive direct synthesis process, of the use of melamine resin products, and of the melamine resin products.

1-24. (canceled)

25. A direct synthesis process for preparing etherified melamine resin condensates with average molecular weights of from 500 to 50 000, the melamine resin condensates are free from hydroxymethyleneamino groups bonded to the triazine rings of the melamine resin condensate and from —NH—CH₂—O—CH₂—NH— groups linking triazine rings wherein
a) in the first step of the reaction, an etherified melamine resin precondensate is prepared in alcoholic solution,
b) in at least one vaporization step, the concentration of the etherified melamine resin precondensate in alcoholic solution is increased, C₄-C₁₈ alcohols, diols of the type represented by HO—R—OH or tetrahydric alcohols based on erythritol or both is added to the melamine resin precondensate prior to, during or after the concentration-increase process or all three,
c) in a second step of the reaction, the increased-concentration melamine resin precondensate is reacted, using a mixer, such as a kneader.

26. The direct synthesis process according to claim 25, wherein, after the second step of the reaction, the etherified melamine resin condensate is discharged and pelletized.

27. The direct synthesis process according to claim 25, wherein the alcohol in the first step of the reaction is methanol.

28. The direct synthesis process according to claim 25, wherein, in the first step of the reaction, a methylolation of the melamine takes place with a subsequent etherification.

29. The direct synthesis process according to claim 25, wherein, in the first step of the process, at least one of formaldehyde and paraformaldehyde is used in the form of formalin solution at variable concentration.

30. The direct synthesis process according to claim 28, wherein the methylolation takes place at a pH of from 7 to 9 and the etherification takes place at a pH of from 5.5 to 6.5.

31. The direct synthesis process according to claim 25, wherein, in the first step of the reaction, a methylolation and an etherification of the melamine take place simultaneously.

32. The direct synthesis process according to claim 31, wherein the first step of the reaction takes place at a pH of from 5.5 to 6.5.

33. The direct synthesis process according to claim 25, wherein the first step of the reaction takes place in the presence of acidic, or of a mixture of acidic and basic, ion exchangers.

34. The direct synthesis process according to claim 25, wherein, in the first step of the reaction, a reaction temperature of from 70 to 160° C., such as from 95 to 100° C., is established.

35. The direct synthesis process according to claim 25, wherein the first step of the reaction is carried out using a melamine/formaldehyde molar ratio of from 1:2.0 to 1:4.0.

36. The direct synthesis process according to claim 25, wherein the increased-concentration melamine resin precondensate obtained after the vaporization process has a concentration of from 95 to 99% by weight.

37. The direct synthesis process according to claim 25, wherein the vaporization of the low-molecular-weight components takes place in two stages.

38. The direct synthesis process according to claim 25, wherein use is made of at least one diol represented by the type HO—R—OH with molecular weight of from 62 to 20 000 or of a mixture of at least two diols represented by the type HO—R—OH with molecular weights of from 62 to 20 000, where the substituent R may have one of the following structures
C₂-C₁₈-alkylene,
—CH(CH₃)—CH₂—O—(C₂-C₁₂)-alkylene-O—CH₂—CH(CH₃)—,
—CH(CH₃)—CH₂—O—(C₂-C₁₂)-arylene-O—CH₂—CH(CH₃)—,
—(CH₂—CH₂—CH₂—CH₂—CH₂—CO—)ₓ—(CH₂—CHR)_{y}—
—[CH₂—CH₂—O—CH₂—CH₂]ₙ—,
—[CH₂—CH(CH₃)—O—CH₂—CH(CH₃)]ₙ—,
—[—O—CH₂—CH₂—CH₂—CH₂—]ₙ—,
—[(CH₂)₂₋₈—O—CO—(C₆-C₁₄)-arylene-CO—O—(CH₂)₂₋₈—]ₙ—,
—[(CH₂)₂₋₈—O—CO—(C₂-C₁₂)-alkylene-CO—O—(CH₂)₂₋₈—]ₙ—,
where n=1-200; x=5-15;
sequences which contain siloxane groups and are represented by the type 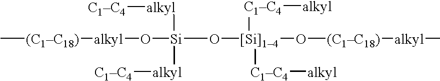
polyester sequences which contain siloxane groups and are represented by the type
—[(X)ᵣ—O—CO—(Y)ₛ—CO—O—(X)ᵣ]—,
where 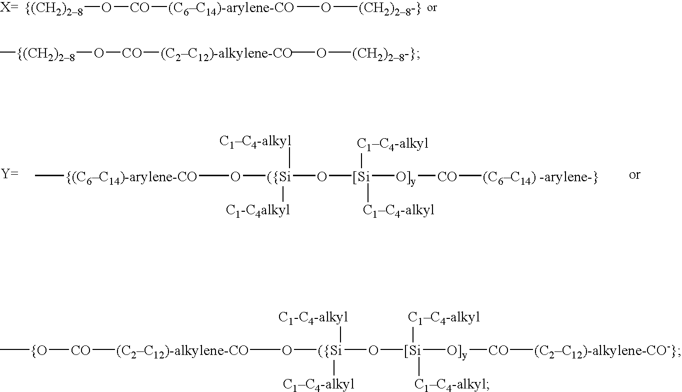
where r=1-70; s=1-70and y=3-50;
polyether sequences which contain siloxane groups and are represented by the type 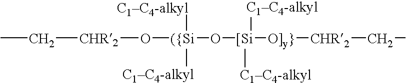
where R′₂=H; C₁-C₄-alkyl and y=3-50; sequences based on alkylene oxide adducts of melamine and represented by the type of
2-amino-4,6-di-(C₂-C₄)alkyleneamino-1,3,5-triazine sequences phenol ether sequences based on dihydric phenols and on C₂-C₈ diols and represented by the type of
—(C₂-C₈)alkylene-O—(C₆-C₈)-arylene-O—(C₂-C₈)-alkylene sequences.

39. The direct synthesis process according to claim 25, wherein the etherified melamine resin condensates are mixtures with average molecular weights of from 500 to 2500 composed of tris(methoxymethylamino)triazine and its higher-molecular-weight oligomers.

40. The direct synthesis process according to claim 25, wherein, prior to or during the concentration-increase process or both, i.e. prior to the first and/or prior to the second vaporizing stage and/or after the concentration-increase process, i.e. prior to the second step of the reaction, anhydrides and/or acids dissolved in alcohols or in water are added to the melamine resin precondensate.

41. The direct synthesis process according to claim 25, wherein the kneader is a continuously operating, at least to some extent self-cleaning, extruder with vacuum venting.

42. The direct synthesis process according to claim 25, wherein the kneader used comprises a twin-screw extruder with vent zones.

43. The direct synthesis process according to claim 41, wherein, in the continuous kneader, up to 75% by weight of at least one of fillers, reinforcing fibres, other reactive polymers of the type represented by ethylene copolymers, maleic anhydride copolymers, modified maleic anhydride copolymers, poly(meth)acrylates, polyamides, polyesters and polyurethanes are also incorporated, as are up to 2% by weight of at least one of stabilizers, UV absorbers and auxiliaries, each weight being based on the etherified melamine resin condensates.

44. The direct synthesis process according to claim 25, wherein the first step of the reaction is executed in a stirred tank or in a continuous reactor.

45. The direct synthesis process according to claim 25, wherein the process is carried out either continuously or batchwise.

46. The direct synthesis process according to claim 25, wherein the melamine resin condensates are free from hydroxymethyleneamino groups bonded to the triazine rings of the melamine resin condensate and from —NH—CH₂—O—CH₂—NH— groups linking triazine rings.

47. Melamine resin products, produced via a melamine resin condensate etherified using a direct synthesis process according to claim 25.
